(19) United States
(12) Patent Application Publication
(10) Pub. No.: US 2009/0271493 A1
(43) Pub. Date: Oct. 29, 2009

(54) System and Apparatus for Managing Social Networking and Loyalty Program Data

(76) Inventor: John C. Boucard, Pasadena, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/111,883

(22) Filed: Apr. 29, 2008

(51) Int. Cl. G06F 15/167

(52) U.S. Cl. 709/213

(57) ABSTRACT

A system for managing and sharing social networking and loyalty program data that includes a quick-transfer device. The quick-transfer device can be in any number of forms that are readily portable such as a keychain, wristwatch, accessory for a mobile phone or music player or similar form. The quick-transfer device provides a set of interactive features for managing and transferring the social networking and loyalty program data through a ‘quick-touch’ or ‘quick-click’ transfer mechanism. The loyalty program and social networking data structure is managed by the quick-transfer device. The data structure is accessible to general purpose applications such as web browsers. The quick-transfer device can communicate with other quick-transfer devices as well as computers and external sensors to update and modify the contents of the stored data structure.

### FIELD OF THE INVENTION

The embodiments of the present invention relate to a method and apparatus for managing social networking and loyalty program data. Specifically, the embodiments of the invention relate to method for managing social networking and loyalty program data through a quick-transfer device that automatically maintains the social network and loyalty program data and interfaces with a backend system through a local computer without requiring a specialized client application.

### BACKGROUND OF THE INVENTION

Loyalty programs are marketing programs utilized by companies and advertising firms to improve sales for the associated company. The loyalty program award points to customers through codes printed on products produced by the company. The user must then access a website provided by the company and input these codes to be credited to an account that the user creates on that specific website. However, this system separates the use of the loyalty program from the use of the product as well as the purchase of the product. Many customers are unwilling to spend the time and effort to create accounts and navigate to the company's loyalty program website to manually input these codes. As a result, loyalty program participation is diminished and the goals of the loyalty program are undercut.

Social networking sites also suffer from similar problems relating to convenience and access for users. Social networking websites provide tools for interacting with friends and business contacts to share information, media and contacts. These resources are sharable through linking accounts in the social networking website and by correspondence via electronic mail. However, in real world social settings these tools are not easily accessible or convenient. Even with the availability of mobile and handheld wireless devices the process of sharing information or sending email to a new contact met in a real world social setting, such as a conference, meeting or social venue is impractical and time consuming involving multiple steps including logging into the site, entering in the new contact information and sending a request to that user typically via email to link the accounts. As a result, the services of the social networking site cannot be relied upon and many potential networking opportunities are lost. Overtime the use of the social networking site is reduced due to these impracticalities.

### SUMMARY

The embodiments of the invention include a quick-transfer device and system for managing the social networking and loyalty program data of the owner of the quick-transfer device. The quick-transfer device stores personal account data of the owner and allows quick sharing of the data by a simple ‘quick-touch’ or ‘quick-click’ transfer mechanism. The social networking and loyalty program data is stored in the quick-transfer device in a format accessible to general purpose applications that can be found on most computers. The quick-transfer device includes processing capabilities to allow the loyalty program and social networking data to be managed through the device itself in interactions with other devices and external inputs. The quick-transfer devices can exchange the social networking and loyalty program data with other quick transfer devices without the intervention of an application on a general purpose computer or other external application.

Connection of the quick-transfer device to a computer with web capabilities allows the user to interact with a backend system provided by the social networking service or the company providing the loyalty program without the use of a specialized client application on the computer. The quick-transfer device includes a set of communication devices that allow it to communicate with other computing devices and other quick-transfer devices. Such communication devices may utilize a Y-shaped connector that guides the orientation of the quick-transfer device with other compatible devices to ensure the establishment of a proper communication link.

### BRIEF DESCRIPTION OF THE DRAWINGS

FIG. 1 is a blocked diagram of one embodiment of the system for social networking or loyalty program data management.

FIG. 2 is a diagram of one embodiment of a quick-transfer device for managing social networking or loyalty program data.

FIG. 3 is a diagram of one embodiment of a data structure for storing and managing social networking and loyalty program data on the quick-transfer device.

FIG. 4 is a flowchart of one embodiment of a process for communication between the quick-transfer device and other computer devices.

FIG. 5 is a flowchart of one embodiment of a process for adding a new social networking or loyalty program account to the quick-transfer device.

FIG. 6 is a flowchart of one embodiment of a process for modifying account data for a loyalty program or social networking account on the quick-transfer device.

FIG. 7 is a flowchart of one embodiment of a process of output data selection for the quick-transfer device.

FIG. 8 is a flowchart of one embodiment of a process of receiving sensor input to modify social networking or loyalty program data on quick-transfer device.

FIG. 9 is a diagram of one embodiment of a quick-transfer device to be placed on a keychain.

FIGS. 10A and B are diagrams of an embodiment of a quick-transfer device in the form of a wristwatch.

FIG. 11 is a diagram of one embodiment of a quick-transfer device coupled to a cellular phone.

FIG. 12 is a diagram of one embodiment of a quick-transfer device coupled with a computer.

FIG. 13 is a diagram of one embodiment of a kiosk to provide interactive capabilities with the quick-transfer device.

FIG. 14 is a flowchart of one embodiment of a validation process.

FIG. 15 is a diagram of one embodiment of a locked content page.

### DETAILED DESCRIPTION

In one embodiment the system for managing and sharing social networking and loyalty program data includes the use a quick-transfer device. The quick-transfer device can be in any number of forms that are readily portable such as a keychain, wristwatch, accessory for a mobile phone or music player or similar form. The quick-transfer device provides a set of interactive features for managing and transferring the social networking and loyalty program data through a ‘quick-touch’ or ‘quick-click’ transfer mechanism. The loyalty program and social networking data structure is managed by the quick-transfer device. The data structure is accessible to general purpose applications such as web browsers. For example, in one embodiment, the data structure is a hypertext markup language (HTML) page that is updated and modified by the processing capacity of the quick-transfer device. The quick-transfer device can communicate with other quick-transfer devices as well as computers and external sensors to update and modify the contents of the stored data structure. The quick-transfer device includes a set of communication devices to enable this interaction. The quick-transfer device can also include an input mechanism that allows the user to select a subset of the stored data to be shared with other quick-transfer devices and computing devices.

When the quick-transfer device is inserted into a computer, the stored data structure either becomes accessible or is automatically accessed by a general purpose application of the computer. This general purpose application loads the data structure and in the process of loading the data structure also loads the associated social networking site or loyalty program site. The data embedded in the data structure is utilized to update the account information for the respective loyalty program site or social networking site. In response, the server for the respective site provides content to be inserted into a display of the stored data structure. This content can also be utilized to update the data structure in the quick-transfer device.

The examples and embodiments described herein below are related to the management of loyalty program and social networking related data. However, one skilled in the art would understand that the components, techniques and principles described herein with regard to loyalty program and social networking related data is also applicable to the management of other similar types of data and systems including online gaming data including massively multi-player online (MMO) data, social group data, membership data, institutional data, government data and similar data sources. For sake of clarity, the embodiments and examples are given in relation to the loyalty program and social networking related data, however, one skilled in the art would understand that the other types of data can also be managed using the same methods and structures.

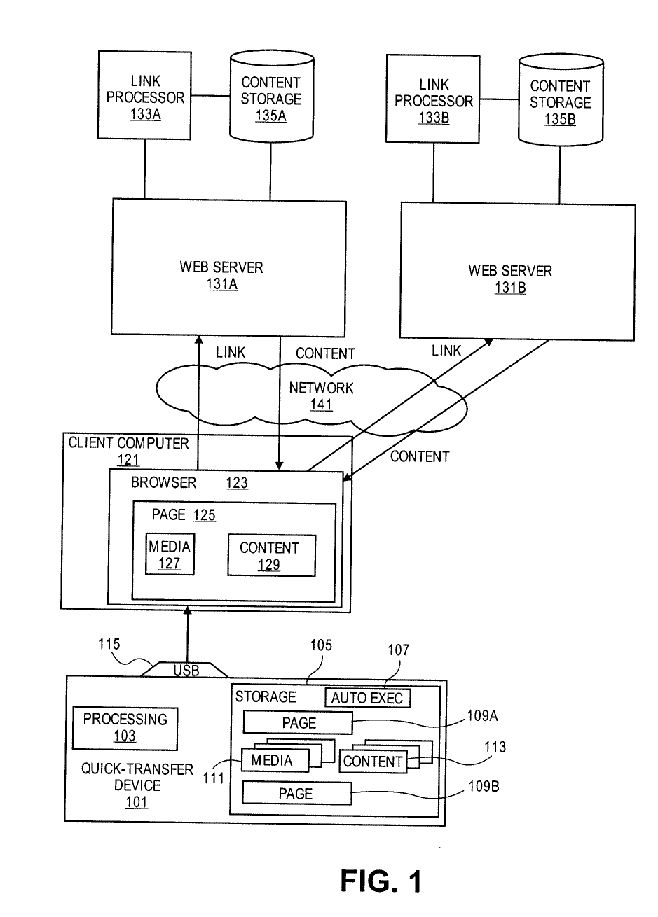

FIG. 1 is a diagram of one embodiment of a system for social networking data and loyalty program data management. The system includes a set of quick-transfer devices 101, a set of client computer 121 and a set of web servers 131A, 131B. A ‘set,’ as used herein, refers to any positive whole number of items. The diagram illustrates a single quick-transfer device and client computer and two web servers 131A and 131B. However, one of ordinary skill in the art would understand that any number of quick-transfer devices, computers and web servers can be used in connection with the system. Quick-transfer devices can be distributed to any number of users. Each user can use their quick-transfer device with their own computers or with any other computer. Any number of companies that are offering loyalty programs or social networking sites could offer their own set of quick-transfer devices or could collaborate with one another to utilize the same set of quick-transfer devices. Each company may provide its own web server to interact with the quick-transfer devices or a set of web servers for multiple loyalty programs or social networking sites may be administered by a third party.

The quick-transfer device 101 can be connected with the client computer 12 through a direct USB connection or similar physical communication mechanism, through a wireless communication protocol, or through a similar communication mechanism. The client computer 121 can connect to any number of web servers 131A, 131B over a network 141. The network 141 can be any type of network including a local area network (LAN), a wide area network (WAN), such as the internet, or a similar network. The network can include any number of wired or wireless components.

The quick-transfer device 101 can have any form factor including a keychain form factor, watch form factor, wireless accessory form factory or similar portable form factory. In one embodiment, the quick-transfer device 101 includes a processing device 103 and storage device 105. The quick-transfer device 101 also includes at least one communication device such as a USB communication device 115. The processing component 103 can be any type of processing component including a general purpose processor, an application specific integrated circuit (ASIC) or similar processing circuitry. A storage device 105 can be any type of persistent storage device including a static random access memory (SRAM) device, electronically erasable programmable read only memory (EEPROM) or similar data storage device.

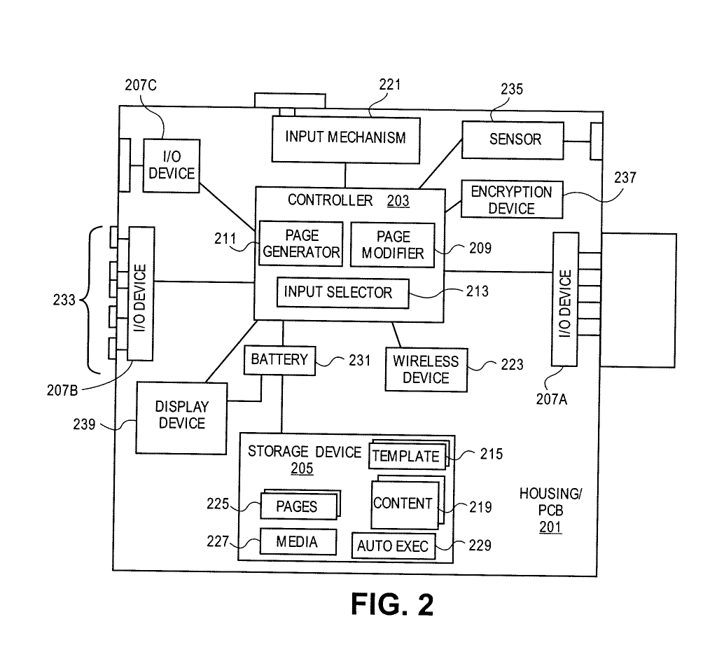

The processing device 103 provides a functionality that includes managing the communication of data through the communications devices 115 and the storage of data in the storage device 105. The processing device 103 also provides the functionality of managing and updating the data structures stored in the storage device 105. In one embodiment, the data structures include a hypertext mark-up language (HTML) document an extensible mark-up language (XML) document or similar document type. The functionality of the processing device is described in greater detail below in regard to FIGS. 2 and 4-8.

The storage device 105 can store any number of separate documents or data structures. In one embodiment, the storage device 105 stores a set of HTML or XML pages 109A, 109B. These pages encode the data associated with social networking or loyalty program accounts that belong to the user of the quick-transfer device 101. The storage device 105 can store media 111 such as images, videos or audio files associated with the pages 109A, 109B. The storage device 105 can store other content 113 including text documents, spreadsheet documents or other types of data that is referenced or incorporated by the pages 109A, 109B. The storage device 105 maintains these separate files as part of a standard file system or file directory.

In one embodiment, the storage device also includes an automatic execution or ‘auto exec’ file 107. The auto exec file is a file that is automatically executed upon detection by an operating system. The auto exec file 107 can be utilized to launch a general purpose application such as a browser 123, upon insertion of the quick-transfer device 101 or the connection of the quick-transfer device 101 with the client computer 121. This enables the quick-transfer device 101 to automatically load a page 109A,109B from the storage device 105. The loading of the page causes the general purpose application to navigate to the appropriate social networking site or loyalty program site. The loading of the page 109A, 109B displays the page 125 and referenced media 127 and content 129 that is provided by the quick transfer device 101 and/or the web servers 131A,B.

The client computer 121 can be any type of computer device including a desktop computer, work station, laptop, console device, wireless device, handheld device or similar computing device capable of executing a general purpose application such as the browser 123 that can interpret the data structure of the quick-transfer device 101 and that can facilitate contact with the web servers 131A,131B over the network 141. The client computer 121 can execute any number of applications and can rely on any type of operating system. A general purpose application such as a browser 123 is utilized by the auto exec file 107 or the user of the quick-transfer device 101 to access and display the stored pages 109A,109B. Displaying the page 125 grants access to the user account information and opens communication to the web servers 131A,131B.

In one embodiment, the web browser 123 is utilized to interpret a page 125 or set of web pages retrieved or made available through the quick-transfer device 101. The web browser 123 may be initiated automatically upon connection of the quick-transfer device 101 by an auto exec file 107 or similar program. The browser 123 interprets each of the elements of the page 125 as received from the quick-transfer device 101. Some of the elements may include media 127, which can be images, audio files or similar content. Other elements include text content, interactive content, such as games or blog features, and other web based content 129.

Each web server 131A, 131B may be associated with a different company or different program or service provided by a company. For example, if a quick-transfer device 101 is linked to a loyalty program, the first web server 131A manages and provides content relating to the account profile and point totals for the loyalty program associated with the user of the quick-transfer device 101. The second web server 131B provides information or interactive features for a company store where loyalty program points can be redeemed. The web servers 131A,131B receive requests in the form of links from the client computer 121 and browser 123 based on the content of the loaded page 125. These links may be in the forms of uniform resource locators (URLs) that encode information about the account of the user of the quick-transfer devices 101 such as new points to be added to the account, rewards to be added to the account, information about other user accounts to be linked to the user account and similar data.

The web servers 131A,131B processes URL data through a link processor 133A, 133B. Link processors 133A,133B can be a software application that interprets the received link information that was embedded in the page loaded by the client computer 121. The link processor then retrieves associated content or data stored in a content storage 135A, 135B. The content storage 135A, 135B can be database or similar data management structure maintained by the social networking or loyalty program site. For example, the link processor 133A,133B can decode received links and determine that the user has earned a new reward or new point total, which is then updated in the content storage 135A,135B, which includes the user account data maintained by the loyalty program or social networking program. Similarly, the received URL or link information can identify another account in a social networking site and indicate that the user has encountered and exchanged data with the user of that account and a request to link the accounts is processed and stored in the content storage 135A, 135B.

One of ordinary skill in the art would understand that the types of account data and features that can be managed by the web server through the link processors 133A, 133B and content storage 135A, 135B can be any of those features or data points that are associated with these sites such as user point totals, user point account information, links with other accounts, reward totals, coupons, personal information and other data that is managed by these social networking or loyalty program sites.

FIG. 2 is a diagram of one embodiment of a quick-transfer device. This diagram is a more detailed view of the quick-transfer device illustrated and described above in regard to FIG. 1. In one embodiment, the quick-transfer device is composed of a printed circuit board 201 within a housing or similar substrate within a similar packaging. In other embodiments, any number of the components of the quick-transfer device may be on separate substrates or not attached to substrates. The quick-transfer device can have any shape or size. In one example embodiment, the quick-transfer device has a form factor of a memory stick that is roughly rectangular with a length between one inch and three inches, a width between 0.1 inches and two inches and a depth between 0.1 inches and one inch. This form factor is provided by way of example and for the sake of clarity in describing an embodiment of the invention. Other example form factors are described below and one skilled in the art would understand that the principles and features of the described embodiments are applicable to other shapes, form factors and sizes.

The quick-transfer device includes a controller 203. The controller 203 can be an ASIC, a general purpose processor or a similar processor or controller. The controller 203 manages the movement of data between the other components of the quick-transfer device and also drives the other components of the quick-transfer device. In one embodiment, the controller 203 also incorporates some or all of the other components of the quick-transfer device. For example, the controller 203 can include a data storage device 205, I/O communication device 207 or similar components.

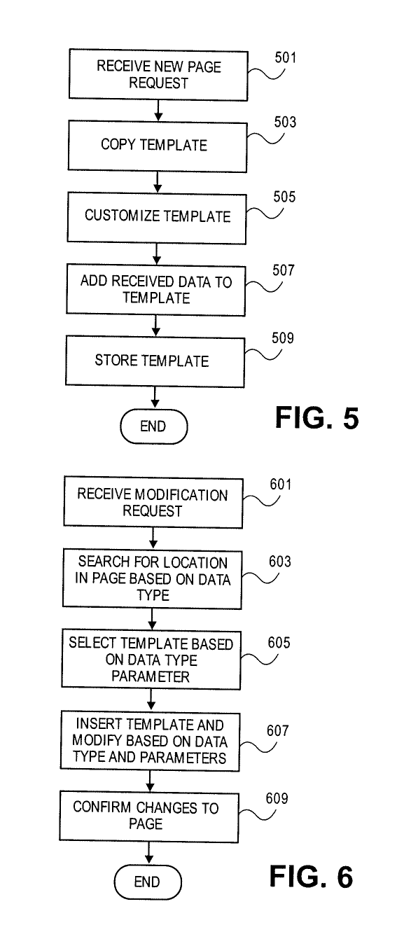

In one embodiment, the controller 203 includes a page generator component 211, a page modifier component 209 and an input analyzer component 213. The page generator component 211 responds to data received over any of the communication ports to generate a new page to be stored in the storage device 205. The new page can be generated from a template 215 and modified to include the received data and then stored as a web page 225 in the storage device 205. The functionality of the page generator component 211 is described in further detail below in regard to FIG. 5.

In one embodiment, the page modifier component 209 responds to data over any of the communication ports to access a web page 225 in the storage device 205 and to modify that page 225, associated content 219 or associated media 227. The functionality of the page modifier component 209 is further described below in regard to FIG. 6.

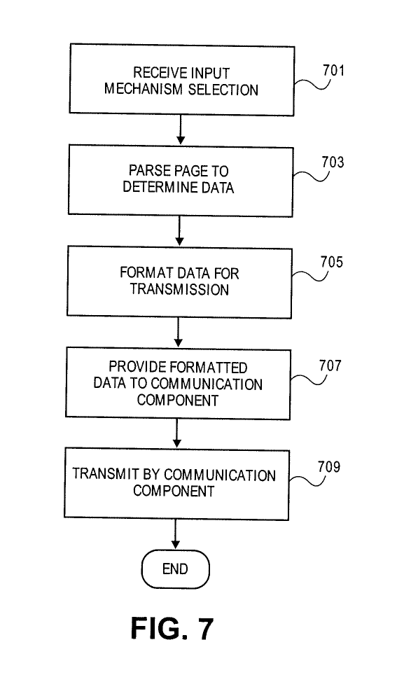

The input selector component 213 processes signals from the input mechanism 221. The input selector component 213 retrieves data from the pages 225, associated content 219 or associated media 227 in the storage device 205. The input selector component 213 prepares the data for output through an I/O device 207A,207B or 207C or through a wireless device 223. The functionality of the input selector component 213 is discussed in further detail below in regard to FIG. 7.

The quick-transfer device includes at least one storage device 205. The storage device 205 can be any type of persistent storage device. The persistent storage device 205 can be an EPPROM storage device, SRAM device or similar persistent storage device. The storage device 205 can be any size and hold any amount of data depending on the type and characteristics of the storage device. In another embodiment, additional storage devices of any type or size can be included. The additional storage devices can be used to store different types of data, provide additional space, or facilitate a simpler design. For example, separate storage devices can be tied to separate input mechanisms, to be output by the quick-transfer device on selection of a corresponding input through the input mechanism 221.

The storage device 205 can store any type of content, links, digital assets, data structures or similar types of data. For example, a storage device may store any number of web pages 225 in an HTML or XML format. The storage device 205 can store any amount of content 219 that might be associated with the web pages 225. The storage device 205 can store any amount of media 227 that may also be associated with the web pages 225. The storage device can store any number of templates 215 that may be utilized to generate new pages 225 or modify existing pages 225. The storage device 205 can also store an auto exec file 229 that might be executed upon connection with an external computer to load the pages 225 to an external application that is launched by the auto exec file 229.

The web pages 225, content 219 and media 227 can be tied to particular loyalty programs, social networking programs, or similar web based systems. For example, a set of pages may be tied to a user's loyalty program, social networking account or similar account. Information related to each of these accounts can be stored or encoded within the pages 225 using any format or data type. For example, data related to user account can be stored in a URL to be resolved by the web browser in combination with the associated website.

The quick-transfer device may also include a battery 231. Any type of battery including an alkaline, lithium, ion, nickel cadmium, nickel metal hydride or similar type of battery can be utilized. The battery 231 provides power source for the quick-transfer device. In another embodiment the battery can be replaced or assisted by other power sources such as external power sources, photovoltaic cells or similar power sources. The housing may be configured to allow easy replacement of the battery 231.

The quick-transfer device can include any number of communication ports or input devices 207A-207C. A first I/O device 207A can be any type of communication port, protocol or medium. The first IO device 207A can be a universal serial bus (USB) port, fire wire port, serial port, parallel port or similar communications port. The first I/O device 207A can be connected to any type of physical connector or dongle. The connector can be male or female connector such as a male or female USB connector. In one embodiment, the second I/O device 207B can be the same type of communication port, controller, protocol or connector as the first IO device 207A. The second I/O device 207B can be a different type of controller including a proprietary type of connector. For example, the second I/O device 207B may control a specialized physical connector that communicates over a set of contact pads 233 with other devices that have a complimentary set of contact pads. In one example embodiment, these contact pads 233 are oriented in a particular shape that requires the complimentary pads to be properly aligned. For example, the shape of the contacts pads 233 can be Y-shaped such that another quick-transfer device or computing device that communicates through the specialized communication system must align its contact pads having complimentary Y-shape to create a communication link between the two quick-transfer devices

A third I/O device 207C can provide an alternative communication medium, connector type or protocol from the first I/O device 207A and the second I/O device 207B. For example, the first and second I/O devices 207A and 207B may primarily utilize physical connections. The third I/O device 207C can be a wireless connection mechanism such as infra-red (IR) or a physical connection type dedicated to a specific device such as a handheld device, cellular communication device or similar device. The third I/O device 207C can be any type of communication port, connector, or communication protocol.

In one embodiment, any of the I/O devices 207A-C of the quick-transfer device can be implemented as a wireless device 223. The wireless device 223 can be any type of wireless device including a Bluetooth, 802.11b/g/n, IR or similar type of wireless communication device. All of the I/O devices can be utilized to transfer and receive data from other electronic devices including other quick-transfer devices, personal computers, console devices, handheld gaming devices, cellular communication devices and similar electronic devices.

In one embodiment, the quick-transfer device includes an input mechanism 221. The input mechanism 221 can be any type of physical input mechanism connected to the electrical components of the quick-transfer device to generate electrical signals to be input into the controller 203 or other components of the quick-transfer device. The input mechanism 221 can be a set of switches, sliders, buttons, dials, touch pads or similar input mechanisms. These input mechanisms can be used individually or in combination to generate input signals that are processed by the controller 203. The input signals can be processed to select data such as a specific page 225 or content 219 associated with a specific page 225 that is stored in the storage device 205.

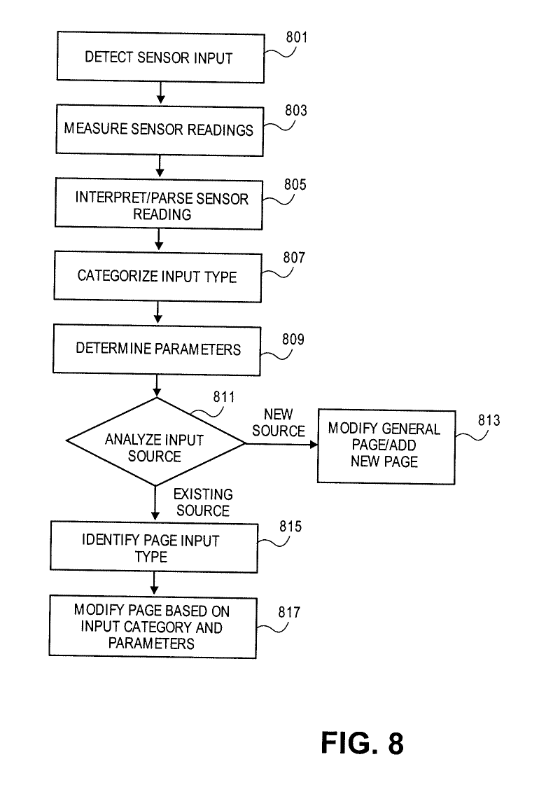

The quick-transfer device can include a sensor 235. The sensor can be any type of detection or sensing device. The sensor 235 can be used to detect any non-digital input such as an electromagnetic, kinetic, energy, light, mechanical or similar force. The sensor 235 can be a resistor, conductive ink, voltmeter, ammeter, ohmmeter, thermometer, photo detector or similar sensor. The sensor 235 can sample or similarly receive the non-digital input to generate an analog value or digital value representing the non-digital input. The sensor 235 can include an analog to digital (A/D) converter or an analog signal may be passed to the controller 203 or separate analog or digital converter. The controller 203 that converts or receives a digital representation of the non-digital input. This non-digital input can be used to modify existing data or can be stored as new data. The process is described below in further detail in regard to FIG. 8.

The quick-transfer device can be an encryption device 237. The encryption device 237 provides security to the quick-transfer device by encrypting and decrypting data transmitted to or from the quick-transfer device or within the quick-transfer device. In another embodiment, the encryption device 237 is a subcomponent of the controller 203. The encryption device 237 also facilitates the management of any protected data managed by the controller 203. The encryption device 237 and the controller 203 can confirm the transfer or deletion of data stored in the data storage device 205. This functionality can be utilized to prevent misuse of the quick-transfer device to dupe the social networking site or loyalty program site. For example, a malicious may user attempt to obtain more points or rewards than they are entitled to by preventing the clearing of new reward or loyalty point program information from the data storage device.

In one embodiment, the quick-transfer device can include a display device 239. The display device 239 can be any type of display device including a cathode ray tube (CRT), liquid crystal display (LCD), light emitting diode (LED) or similar display type. The display device 239 can include a graphics controller or the controller 203 can drive the display device 239. The quick-transfer device can include any number or size of display devices 239. The display device 239 can provide any resolution and color range including black and white or gray scaled graphics.

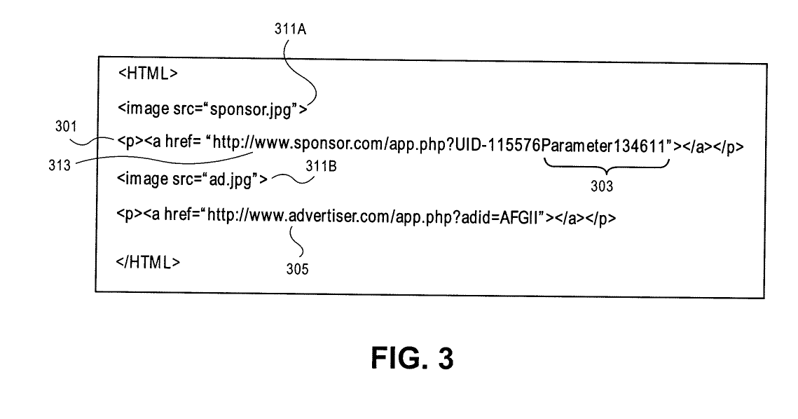

FIG. 3 is a diagram of one embodiment of an example data structure managed by the quick-transfer device. In one example embodiment, the data structure is an HTML or XML document. The HTML or XML document can have any content utilizing the HTML or XML format. The quick-transfer device can update or modify the content of the HTML or XML document in response to external data input from computers, quick-transfer devices and the input mechanisms on the quick-transfer device. Modification of the data structure can include inserting, changing or removing links, text, content or similar elements. In one embodiment, each user account is separately implemented as standard page that includes links, content and media related to that account. In another embodiment, multiple accounts can be implemented through a single page.

In an example embodiment, the data structure includes a set of links 301, 305 and images 311A, 311B. The data structure can include any number of images or other media and any number of links or other content. The links are directed to the website of the account provider 301 or an advertiser associated with the account 305. The links include a portion that identifies the web server 313 and another portion 303 that embeds information about the user's account. Either of these elements can be modified by external sources to change the account information associated with the quick-transfer device using the processes described herein below.

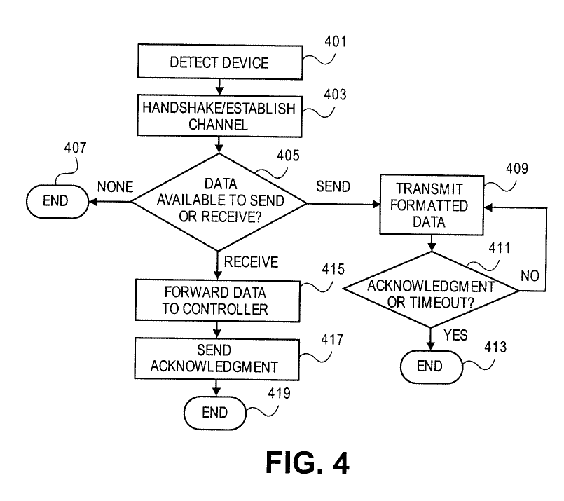

FIG. 4 is a flowchart of one embodiment of a process for establishing communication between the quick-transfer device and another device. This process can be executed by the controller. The process can be initiated in response to a detection of a physical connection or wireless connection with another device (block 401). Such connections can be monitored by the controller through the various I/O devices as well as the sensor of the quick-transfer device. Upon detection of the presence of another device a handshake process is initiated to establish a communication channel with that device (block 403). Any handshake or process can be utilized to establish the communication channel. Handshake processes vary depending on the type of connection that is being made. For example, a USB connection to a client computer utilizes a handshake or process for establishing communication specific to the USB protocol.

The controller of the quick-transfer device then communicates over the established connection with the newly connected device to determine if that device has any data to send to the quick-transfer device. The controller also checks the status of the data in the local data storage device to determine whether the quick-transfer device has any data to send to the newly connected device (block 405). The newly connected device can signal through any predefined messaging that data is available to be sent to the quick-transfer device. Similarly, the quick-transfer device can identify the type of device it is connecting with and determine whether there is any data to be sent to that type of device such as a particular page in the data storage device.

If there is data to be received from the newly connected device, a ready signal can be sent to the newly connected device to initiate the transmission of data through the connecting I/O device. The controller manages the processing and storage of transferred data into the storage device (block 415). After completion of the transfer of data to the quick-transfer device an acknowledgment is sent to the connected device (block 417). The connection is then closed (block 419).

If data is available to send to the newly connected device, then the controller initiates the retrieval of this data from the data storage device and forwards it to the connected device through the appropriate I/O device (block 409). The data may be formatted for the particular communications protocol employed by the communication channel. Upon completion of transmitting the data, the quick-transfer device waits for an acknowledgement from the connected device or starts a time out process (block 411). If an acknowledgment is received before the time out expires, then the communication channel may be closed (block 413). In some embodiments, if sensitive data was transferred or data designated as unique was transferred, then this data may be erased from the data storage device or the data storage device data may be modified to reflect this transfer.

In some embodiments, if no acknowledgement is received or a timeout occurs, then the data is retransmitted (block 409). In other embodiments, a rollback of any transaction associated with the transmission may be performed. For example, if data is being transferred from the data storage device to the external device that is labeled as having a unique characteristic or security sensitivity, such that only single copy of that data is to be maintained, then that data may be retained by the quick-transfer device since it was not successfully transferred to the other device.

FIG. 5 is a flowchart of one embodiment of a process for creating a new page in the quick-transfer device. The quick-transfer device receives a signal that indicates that a new user account is to be established for the account. This can be done at the point the quick-transfer device is initiated or at any point during its operation, the quick-transfer device can generate a new page in response to an external input that is designed to provide a new feature or just to provide additional information for an existing user account that is to be segmented to a different page. The process is initiated by receiving the new page request (block 501). The new page request can be received over any I/O device communication channel. The new page request can also be initiated in response to user input through a local input mechanism. A page generator in the controller can execute this process.

In response to receiving the new page request, a template is identified based on data related to the request and a copy of the template is made in the data storage device (block 503). In other embodiments, a new page request includes a page template or basic starting page. After the template has been copied, the template may be customized to be associated with a specific user account and loyalty program or social networking site. The template is customized by adding links, images, content or other elements to the template (block 505). In one embodiment, the template is a basic HTML form and additional elements are added by adding new links and tags to the basic template. Data that is received from an external data source may form part of the added material that is used to customize the template (block 507). After the modifications have been completed, the template is stored in the data storage device (block 509). Any associated content, media, or other data that is associated with the newly stored page can also be stored in the storage device. The organization of the data may be in a file structure organization or similar organization.

FIG. 6 is a flowchart of one embodiment of a modification process. This process is initiated in response to receiving the modification request (block 601). The modification request can be received over any communication channel established by the quick-transfer device. The modification request can have a specific data type or may identify a particular account that it is associated with. A search for an associated page in a location within that page is conducted (block 603). The search can be based on the data type or on other parameters provided with the modification request.

Based on the specified data included with the modification request, a template which may be a code segment, is retrieved from the data storage device (block 605). For example, if a new link is to be added to an existing page, then the appropriate XML or HTML code for creating a link is retrieved as a template from the data storage device and then modified to include the data received as part of the modification request. In another embodiment, the modification request itself specifies the exact code to be entered into the designated page.

The selected and modified template is inserted into the designated page (block 607). The location of the template data and the parameter data can be specified by the request or can be determined based on the type of data retrieved or received. For example, a page can have a specific tabular layout where certain types of data are inserted into certain correlated fields in the table to create a specific layout. Further to this example, if the received modification request is to update the number of points in the loyalty program for a user, then a particular field or existing link in the page is modified by replacing the link with the template information or combining the existing information with the template information.

After the modification has been made to the page data, the changes are confirmed and stored in the data storage device (block 609). Modifications can be made to a temporary copy of a page and utilized to replace the original copy of the page to avoid data corruption in the case of an interrupted operation.

FIG. 7 is a flowchart of one embodiment of a process for input selection. The user of a quick-transfer device can select particular stored data or pages to be output through an input mechanism of the device. The input selection process can be executed by an input selector of the controller. In one embodiment, the process for selecting an output is initiated in response to receiving an input selection (block 701). The input mechanism can be a slider mechanism, dial mechanism, set of buttons or similar input mechanism. Each of the different types of input or combinations of input can be associated with a unique identifier or code. Each of these codes are associated with a different set of data within the stored pages. In one embodiment, the input mechanisms can be used to select a specific page and a specific item within a page to be output. Upon receiving the selection information, the quick-transfer device parses the pages to obtain the data at the designated location (block 703). The retrieved data is then formatted for transmission according to the protocol of the communication connection (block 705). This formatted data is then provided to the I/O connection or the communications channel (block 707). The communications connection then transmits the data over the communications channel (block 709).

In another embodiment, input selection is initiated in response to receiving an external input such as a message through a communications component or a sensor input. The external input can provide an indication of a specific page or specific item within the page to be output. The external input can encode this selection using any encoding scheme including any analog or digital encoding scheme. These encoded external inputs can be analyzed and processed in the same fashion as the input from the input mechanism.

FIG. 8 is a flowchart of one embodiment of a process for handling sensor data. The quick-transfer device may detect or receive non-digital input through a sensor device. The sensor may continually attempt to detect input or the sensor may be enabled by a user selection of the sensor. The process can be initiated in response to the detection of the sensory input (block 801). The sensor then measures the relevant or associated phenomenon in a format dependant on the type of the sensor (block 803). For example, a sensor can be a photosensitive sensor that detects light sources. The light source has a particular pattern or intensity that is measured by the sensor.

The received measurement is then translated into a digital value. The translated can be accomplished by an analog to digital converter. The translated value is then interpreted or parsed by the quick-transfer device (block 805). Specific digital values or patterns of values can be associated with specific values or can be direct translations into the relevant values.

The received data is then categorized into specific input types (block 807). The input type can indicate a specific command such as a page generation request or a page modification request. The input data may also include a set of parameters associated with the set of requests or commands that are determined by the analysis of the sensor data (block 809). The controller analyzes the input as it is translated into a specific command and set of parameters (block 811). If the command is to generate a new page, then the controller calls the new page generator (block 813). If the input is interpreted as indicating that an existing page should be modified, then the page modifier component is called and the specific page to be modified is identified (block 815). After the specific page has been identified then the page modifier component carries out the modification based on the input parameters (block 817).

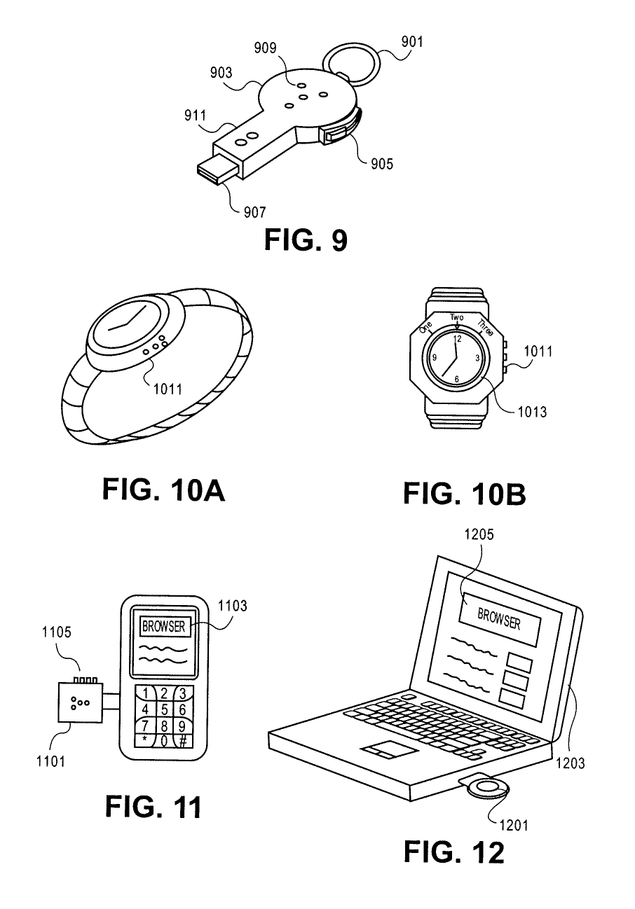

FIG. 9 is an illustration of one embodiment form factor of the quick-transfer device. This embodiment is in a key chain form factor. The quick-transfer device includes a key ring 901, a main housing 903, an input mechanism 905, a first connector 907 and a second connector 909.

The housing can have any shape or dimension. The exterior of the housing can also have any manner of printed material, branding or theme. For example, the exterior can have a logo or identifier linking it to the social network or loyalty program to which it is primarily associated. The molding of the housing can also reflect this association or can be used as a novelty aspect. For example, a loyalty program associated with the zoo may have an animal shaped quick-transfer device.

The input mechanism in 905 in this example is a slider. A protruding slider moves within a track. Different positions in the track can be utilized to select specific pages or page elements stored in the quick-transfer device to be output to either of the connectors 907 or 909.

In this example embodiment, the quick-transfer device includes a USB connector 907 and a specialized Y-connector 909. The USB connector 907 can connect any device having a complimentary USB port and utilizes a standard USB protocol for communicating with another device. The specialized Y-connector can have any type of protocol associated with communication over the contact pads that compose the connector 909. The contact pads are aligned in either close proximity to or touching a similar connector and can be used to transmit data either through an analog protocol or a digital protocol across a set of pads. The organization of the pads into a Y shape assists the users in orienting the devices for the quick and correct transfer of data.

In one embodiment, a display device and set of LEDs 911 assist the user in providing the user information about the status of data transfers. The color of the LEDs changes or the LEDs are enabled or disabled based on the status of the connection with another device or the communication of data with another device. For example, the LEDs blink during the connection or transfer and a green LED changes to red upon on a successful transfer.

FIGS. 10A and 10B illustrate two embodiments of a watch form factor. The watch form factor has the components of the quick-transfer device embedded behind the face of the clock or any other component of the watch. The watch can include a connector 1011 and can be a functioning watch. In one embodiment, the watch includes a dial 1013 that is used to select one of any number of data items stored within any number of pages within the device. Rotation of the dial to a select position changes the output of the connection pads 1011.

FIG. 11 is a diagram of one embodiment of a cellular phone accessory. The quick-transfer device 1101 is connected to the cellular device through any type of communication port including specialized communication ports, USB ports or similar communication ports. A browser may be activated by the user or automatically activated by the connection of the quick-transfer device to allow the user to view the contents of stored pages through the browser 1103. The user can change the displayed page by selection of page or content of the page using the input mechanism 1105. A master page or similar mechanism may also be stored on the quick-transfer device that allows the user to select other pages by navigational links in the master page that serves as a table of contents.

FIG. 12 is a diagram of one embodiment of a quick-transfer device connected to a computer. In one embodiment the quick-transfer device can be connected through any type of communications port of a computer 1203. The communications port can be a serial communications port, parallel communications port, wireless communications port, USB connector or similar communications port. Upon insertion or connection of the quick-transfer device 1201 to the computer, an auto exec file can be executed much in the same manner an auto exec file is executed by insertion of a compact disc or similar type of media. This initiates the browser or similar purpose application that was resident on the local computer 1203. The browser then interprets the designated page on the quick-transfer device and resolves the links by communications with the associated website.

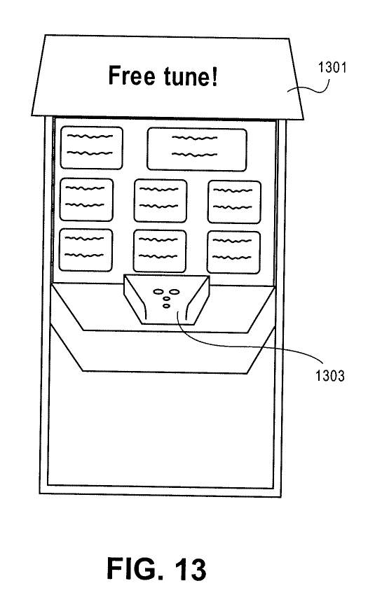

FIG. 13 is a diagram of a kiosk which offers content for the quick-transfer device. A kiosk 1301 can be used by a provider of the quick-transfer device in a real world shopping context. A social networking or loyalty program provider can provide any type of content through such a kiosk that includes a connector that is compatible with quick-transfer device 1303. A user approaches a kiosk and initiates a communication link between the quick-transfer device and the kiosk through the connector 1303. The kiosk automatically transfers data to the quick-transfer device. Data can include commands to modify an existing page, add a new page, add content to an existing page or new page or similarly modify the content of the quick-transfer device. For example, the loyalty program may provide a free audio file, video file, coupon, set of points or similar perk to a user at a shopping venue. The user can obtain this quickly by making a connection with the quick-transfer device. The perk may actually be transferred through the connection directly or may be made available to the user by modification or the storage of a new link in the associated web page of the loyalty program that can be obtained upon connecting with the associated website.

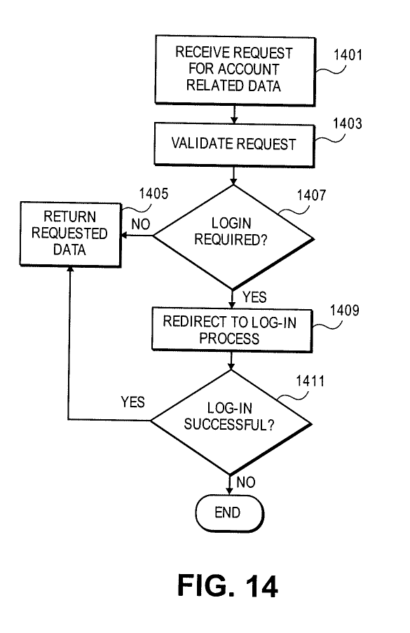

FIG. 14 is a flowchart of one embodiment of a validation process. In some embodiments, a validation process is utilized by a web server or similar component of the system to prevent unauthorized access to or modification of user account data. Such unauthorized access may be attempted through misappropriation of the user's quick-transfer device, or by requesting links from the web servers using spoofing or similar techniques.

In one embodiment, the process is initiated in response to a receiving a request from for account related data (block 1401). This request can include a request for data specified by a link or similar indicator. The web server can check whether requested data is tied to a specific user account, such as user loyalty program point totals or similar data. If the data is user account linked then a validation process is executed. If the data is not associate with a user account, then the request can be serviced without validation.

In one embodiment, a request is validated using a specific validation algorithm or scheme (block 1403). This can be a check of an identifier associated with a quick-transfer device such as a batch number, unique identifier, password or similar data. Other synchronization or security measures can be integrated with the quick-transfer device and implemented between the device and the server. For example, the server and quick-transfer device could utilize shared encrypted keys, shared clocks or counters like RSA security tokens, or employ similar validation techniques to ensure that a request is originating from a valid quick-transfer device. The input mechanism can also be utilize to input a passcode, passphrase or other validating information or to cause the quick-transfer device to output the validating information. In other embodiments, a discrete validation of the quick-transfer device is not relied upon or is used in conjunction with controlled access to the requested data.

A check can be made by the server to determine whether a user login to the web site is required (block 1407). A login can be required any time a new access to account information is made during a session or if other continuity data is not present like a cookie or similar data that allows a user to remain logged in over multiple sessions. If no login is required for a specific data request, then the requested data is returned (block 1405). If the login is required, then the web server redirects the user to a login process (block 1409). Any type of login in process can be used including a simple password based login a password and dynamic graphic matching or similar user validation login or similar login process. A check is made to determine the success of the login (block 1411). A failed login can end the process. A successful login initiates the retrieval and return of the requested data.

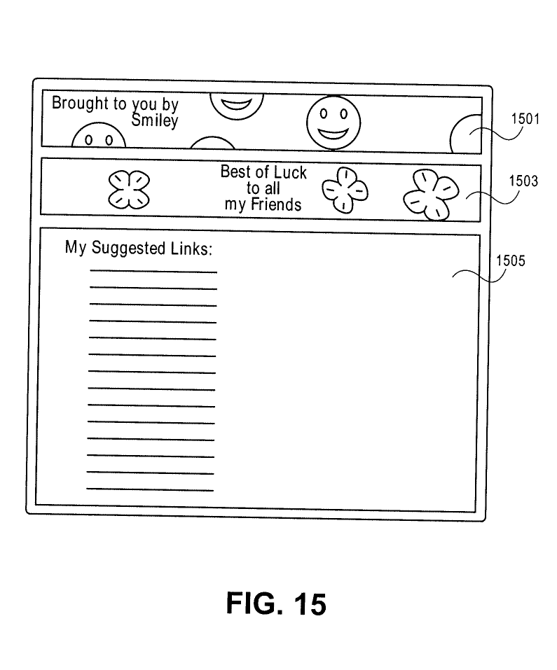

FIG. 15 is a diagram of one embodiment of a locked content page. In one embodiment, the quick-transfer device can manage locked, fixed or secured content. This content can be loaded into the quick-transfer device by a manufacturer, distributor or user of the quick transfer device. The locked, fixed or secured content may be permanently added to the content of the quick-transfer device or its modification may be controlled through any protection scheme including password protection, physical lock or similar protection. Any type of content can be locked, fixed or secured. For example, a banner ad 1501, frame 1503 or similar portion of a web page may be fixed, locked or secured. The data can be text, audio, video, program or similar data.

In one example, a manufacturer or distributor ads a banner ad 1501 to the main web page stored on the quick-transfer device. The user can also ad a banner or frame 1503 and fix it with a password or similar process. The user could then pass it on to another owner. Each owner could add their own locked, fixed or secured content. Other standard modifiable content 1505 can also be maintained by the quick-transfer device as described above.

In one embodiment, the quick-transfer device, its components and the associated data management system are implemented as hardware devices. In another embodiment, these components are implemented in software (e.g., microcode, assembly language or higher level languages). These software implementations are stored on a machine-readable medium. A “machine readable” medium may include any medium that can store or transfer information. Examples of a machine readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving data by a handheld device through a sensor or communication port;
forwarding the data to a controller of the handheld device;
parsing the data to identify a type of the data and parameters in the data by the controller;
modifying a markup language document stored in a local storage device in the handheld device automatically based on the type of data to create a modified document; and
storing the modified document in a local storage device in place of the document.

2. The method of claim 1, further comprising:
selecting a template automatically based on the type of the data, the template having a format of the markup language; and
inserting the template into the document.

3. The method of claim 2, further comprising:
identifying parameters within the data; and
modifying the template based on the parameters.

4. The method of claim 3, wherein the template defines a link to a website.

5. The method of claim 4, wherein modifying the template comprises:
inserting the parameters into the link.

6. The method of claim 1, wherein the parameters encode social networking data, loyalty program data, or account data to be interpreted by a server.

7. The method of claim 1, further comprising:
identifying a source of the data; and
generating a new markup language document in response to identifying the source as a new source.

8. The method of claim 1, further comprising:
transmitting validation information to a server including identification information for the handheld device.

9. The method of claim 1, further comprising:
detecting an external input; and
outputting a stored portion of the markup language document identified by the external input.

10. A device comprising:
a storage device to store a markup language document;
a communication device to receive data from another device;
a controller coupled to the communication device to process the data and automatically modify the markup language document based on a data type and parameters within the data.

11. The device of claim 10, wherein the controller further comprises:
a page generator component to retrieve a markup language template based on the type of the data.

12. The device of claim 10, wherein the controller further comprises:
a page modifier component to retrieve a markup language template based on the type of data and insert the template into the markup language document.

13. The device of claim 10, further comprising:
a physical input mechanism coupled to the controller to select a page or a portion of a page to output through the communication device.

14. The device of claim 10, further comprising:
a sensor to measure an analog signal to be converted into digital data,
wherein the controller converts the digital data into parameters and modifies the markup language document to include the parameters.

15. The device of claim 10, wherein the storage device is a static random access memory or flash memory.

16. The device of claim 10, wherein the device has a form of a wearable and functional wristwatch.

17. The device of claim 10, further comprising:
a Y-shaped connector coupled to the communication device.

18. A machine readable storage medium, having instructions stored therein, which when executed cause a computer to perform a set of operations comprising:
receiving data by a handheld device through a sensor or communication port;
forwarding the data to a controller of the handheld device;
parsing the data to identify a type of the data and parameters in the data by the controller;
modifying a markup language document stored in a local storage device in the handheld device automatically based on the type of data to create a modified document; and
storing the modified document in a local storage device in place of the document.

19. The machine readable storage medium of claim 18, having further instructions stored therein, which when executed cause a computer to perform a set of operations further comprising:
selecting a template automatically based on the type of the data, the template having a format of the markup language; and
inserting the template into the document.

20. The machine readable storage medium of claim 18, having further instructions stored therein, which when executed cause a computer to perform a set of operations further comprising:
identifying parameters within the data; and
modifying the template based on the parameters.

21. The machine readable storage medium of claim 19, wherein the template defines a link to a website.

22. The machine readable storage medium of claim 20, wherein modifying the template comprises:
inserting the parameters into the link.

23. The machine readable storage medium of claim 18, wherein the parameters encode social networking data, loyalty program data, or account data to be interpreted by a server.

24. The machine readable storage medium of claim 18, having further instructions stored therein, which when executed cause a computer to perform a set of operations further comprising:
identifying a source of the data; and
generating a new markup language document in response to identifying the source as a new source.

25. The machine readable storage medium of claim 18, having further instructions stored therein, which when executed cause a computer to perform a set of operations further comprising:
transmitting validation information to a server including identification information for the handheld device.

26. The machine readable storage medium of claim 18, having further instructions stored therein, which when executed cause a computer to perform a set of operations further comprising:
detecting an external input; and
outputting a stored portion of the markup language document identified by the external input.
